(19) United States
(12) Patent Application Publication
(10) Pub. No.: US 2005/0150324 A1
(43) Pub. Date: Jul. 14, 2005

(54) Door electromechanical operator

(76) Inventor: Bernd Brieseck, Plettenberg (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/515,131

(22) PCT Filed: Oct. 10, 2003
(86) PCT No.: PCT/EP03/11236

(30) Foreign Application Priority Data
Oct. 10, 2002 (DE) 10247277.7

(51) Int. Cl. F16H 57/02

(52) U.S. Cl. 74/606 R

(57) ABSTRACT

An electromechanical drive unit for a door closer for swiveling leaves of doors or the like, having a housing which comprises a bottom shell and a top shell and which receives the drive elements of the door drive. Receptacles for fixedly positioning drive elements of the door drive are arranged within the bottom shell and/or top shell of the housing and are formed in one piece with the housing.

The invention is directed to an electromechanical drive unit for a door which is constructed as a swiveling leaf or the like, with a housing which comprises a bottom shell and a top shell and which receives the drive elements.

DE 32 02 930 A1 discloses a door closer of the generic type whose square housing has a base plate and a carrier plate for receiving the drive elements. The housing can be closed by a cover. The drive elements arranged in the interior of the housing are apparently connected to the housing by screw connections; at least the rolling bearings for the driven shaft are screwed to the above-mentioned carrier plate by the bearing shells of the rolling bearings.

U.S. Pat. No. 4,501,090 describes a door closer in which the drive elements and control elements are arranged on both sides of a carrier plate. A motor and a control unit which measures the opening angle of the door are connected on one side of the carrier plate and a gear train of a gear unit is connected on the other side of the carrier plate of the gear unit housing. The rolling bearings of the gear train are supported in reinforced wall areas of the gear unit housing.

In the closer housing according to U.S. Pat. No. 4,727,679, additional plates which are connected to the housing and which receive bearings or bearing pins of the individual toothed gears of a gear train driven by an electric motor are arranged inside the housing.

DE 695 17 013 T2 is directed to a window operating device which is arranged at a window frame and in which a connector comprising a plurality of members which are swivelable relative to one another is mounted and guided in a housing formed of a base and a cover in such a way that the connector can slide in a guide arranged in the base. The connector which is connected to a window at the other end can be moved out of and into the housing by manual actuation or motor actuation. The guide is an integral component part of the base; this is also true of a pin which forms an integral part of the base and on which a chain wheel driving the connector is rotatably mounted. The integral construction of the guide and pin is intended to obviate more complicated types of construction. Insofar as a motor drive is used, the drive elements are arranged on a special mounting yoke which is connected to the base by means of fastening elements, i.e., screw connections.

A relatively similar window operator is disclosed in DE 39 36 136 A1. The prior art window operator has a housing which can be screwed to a bottom part by a flange and which forms the cover in practice. All of the drive elements, including an electric motor, are arranged in the housing. The motor acts on a gear unit and the geared connection between the motor and gear unit can be interrupted by a clutch depending on the loading of the closing mechanism. One of the two coupling members, which can be separated from one another, is acted upon by a wave spring which is tensioned between a bottom side of a top part, i.e., of a wall of the housing, and the coupling member.

The prior art door drives are uneconomical with respect to the manufacture and assembly of the connection of the individual drive elements to the housing of the door drive. The screw connections which are known from the prior art require a large number of loose parts; they necessitate additional fastening flanges at the individual drive elements and are difficult to assemble and repair due to the loose parts.

It is the object of the invention to provide a reliably operating drive for a door closer which can be produced extremely economically. The invention is based on the idea of finding a solution for the connection of the individual drive elements to the housing, i.e., for fastening the drive elements to the housing, which facilitates assembly, i.e., is time-saving and economical. Nevertheless, it is ensured that force-transmitting drive elements in particular, such as the motor and gear unit elements, are reliably positioned in their operating position.

The above-stated object is met by the invention in accordance with the teaching of claim 1.

Further advantageous features of the invention are characterized by the subclaims.

It will be seen that screw connections or the like for the connection of the drive elements to the housing can be dispensed with according to the invention. Since the individual drive elements need only be inserted into a shell—preferably the bottom shell—of the housing, there is already a considerable advantage when assembling the door drive. This is also true for maintenance or exchange of individual drive elements in case of repair. The control unit itself can be constructed in a manner known per se and can be adapted to the respective requirements. On the whole, a simple swiveling door drive is provided which can be installed economically, for example, on all doors of residences with access for the disabled.

The receptacles which are constructed, according to the invention, integral with the housing are suitable for positioning the individual drive elements of the door drive in a reliably fixed manner so as to ensure that the force-transmitting elements in particular, namely, the motor and gear unit, are definitely fixed. The receptacles can be constructed differently with respect to the drive elements that are to be fixed in the housing of the door drive and can be adapted to the respective drive elements. With respect to the bearing shells of the sliding bearings or rolling bearings, the receptacles are constructed in such a way in a construction of the invention that they entirely or partially enclose the bearing shells of these drive elements.

In this respect, it has proven advantageous that corresponding receptacles with respect to the bearing shell of a drive element are arranged in the bottom shell and in the top shell, so that the bearing shells are practically entirely enclosed and are fixed in position.

In areas that are particularly stressed, for example, with respect to the bearing support of the motor or of individual gear unit elements, it is further suggested that the receptacles have inserts such as metal bushings, threaded bushings or the like which—insofar as the bottom shell or top shell is made of plastic—can be glued to the plastic, for example.

It will be seen that an embodiment of the invention can be constructed in such a way that the fixed positioning of drive elements that are held in receptacles of the bottom shell is carried out by means of a frictional engagement with the top shell having the complementary receptacles.

In the embodiment form mentioned above, all of the drive elements, such as the transformer, control unit, motor and gear unit, can advantageously be inserted with the driven shaft of the gear unit into receptacles that are formed integral with the bottom shell and can be secured by connecting to the top shell.

For this purpose, the housing can be divided into a bottom shell and a top shell along its entire length. However, the invention can also be realized in such a way that the top shell extends only along the area of the bottom shell receiving the motor and gear unit, while the area receiving the control unit has, at least along part of its length, a cover which is formed integral with the bottom shell.

The invention according to claim 1 can also be realized in such a way that the top shell is divided with respect to its longitudinal extension into an area covering the transformer and control unit and an area covering the motor and the gear unit. This embodiment form enables selective access to the area of the door drive containing the control unit or to the area of the door drive containing the mechanical drive elements for purposes of repair without having to open the other respective area.

Another suggestion for meeting the object stated above consists in that the receptacles are constructed as holding claws which are formed integral with the base or side walls of the bottom shell and which fix the control unit, motor and gear unit; the complementary receptacles arranged in the top shell are omitted. In this case, the top shell functions solely as a cover; the holding claws mentioned above lock the individual drive elements reliably in all three planes.

In a development of the invention, the motor housing of the electric motor can be omitted in order to further reduce costs; the connection of the motor can be carried out by means of the bearing shells of the motor shaft which are locked in the above-mentioned holding claws.

The housing itself can be made of any material. It is essential that the receptacles or holding claws are formed integral with the respective material; this can be realized, for example, in a housing made of plastic, die-cast zinc, die-cast aluminum, or the like.

The invention will be described more fully in the following with reference to five embodiment examples.

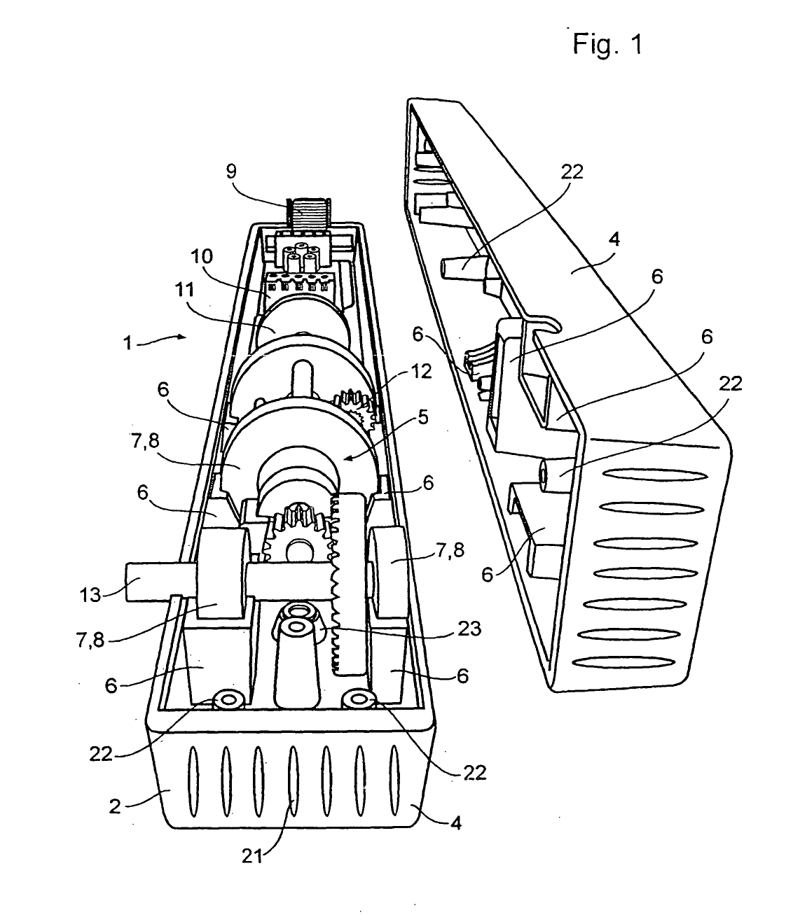

FIG. 1 is a perspective view showing a first embodiment example of a housing in which the bottom shell and top shell are continuous along the entire longitudinal extension;

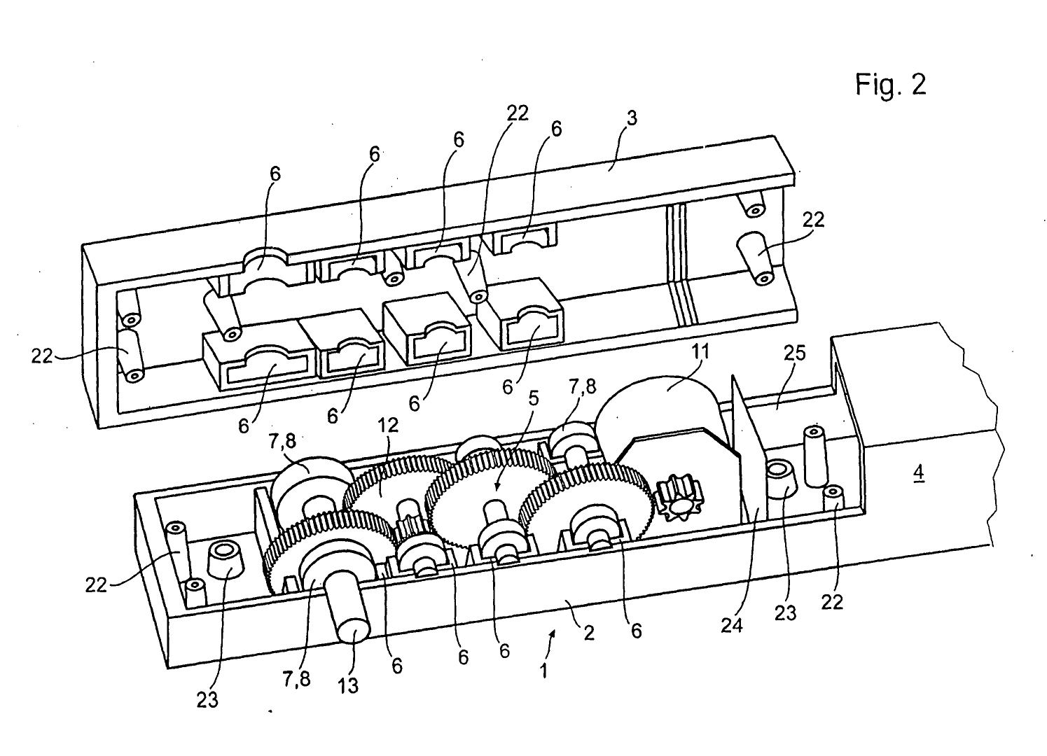

FIG. 2 is a perspective view showing a second embodiment example of a housing in which a top shell is continuous along only part of the longitudinal extension;

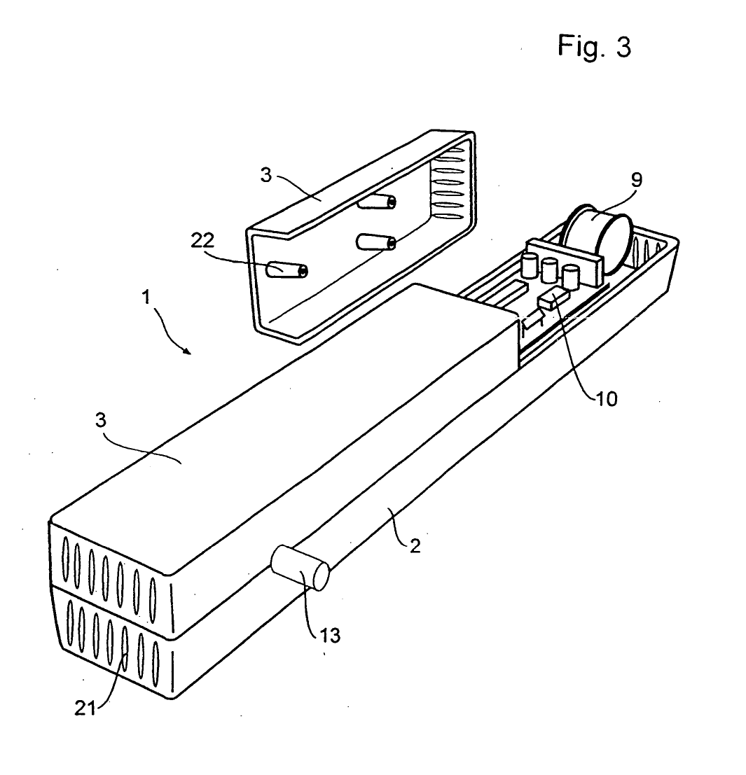

FIG. 3 is a perspective view showing a third embodiment example of a housing with a top shell which is divided along the longitudinal extension;

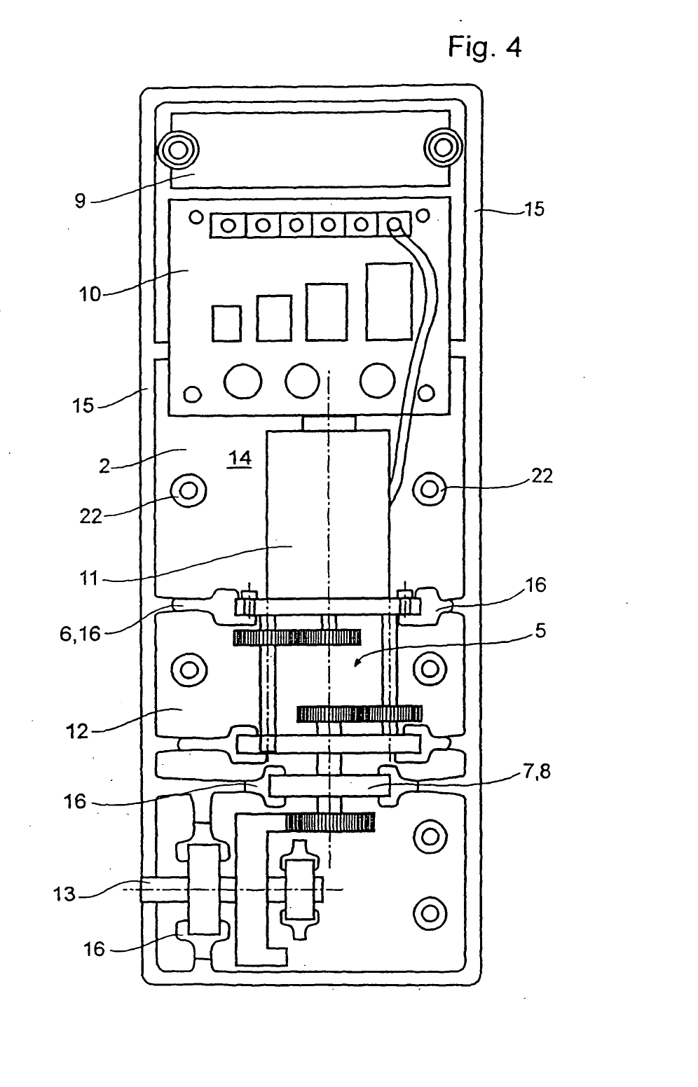

FIG. 4 is a top view of a bottom shell in a fourth embodiment example with receptacles that differ from those in FIGS. 1 to 3;

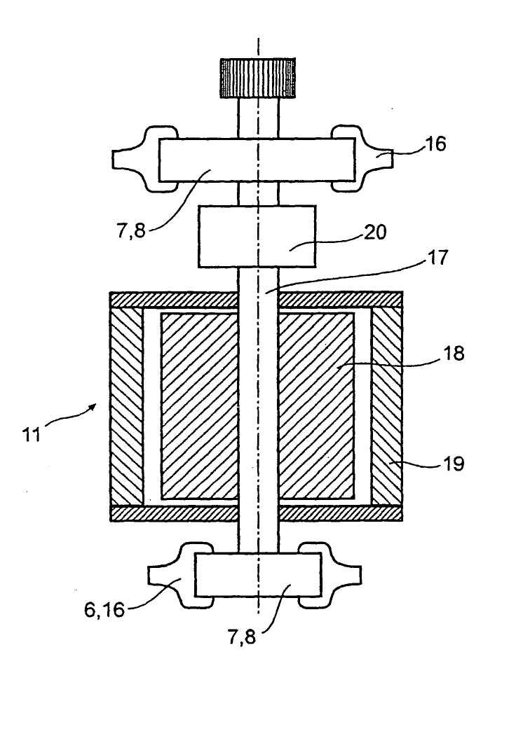

FIG. 5 shows a section through an electric drive motor, wherein a motor housing is omitted.

In the embodiment example according to FIG. 1, a door drive 1 has a bottom shell 2 and a top shell 3 which together form a housing 4. The bottom shell 2 can be connected to a base plate, not shown, e.g., by means of connection sleeves, designated by 23. Drive elements, designated generally by 5, are inserted into receptacles, designated generally by 6, in the present embodiment example. The receptacles 6 are arranged at the bottom shell 2 and at the top shell 3 and are constructed integral with the shells. It can be seen that the receptacles 6 can be constructed differently; they are adapted with respect to their contour to the individual drive elements to be secured. In this way, the receptacles 6 of the bottom shell 2 and of the top shell 3 can complement one another in such a way that the drive elements 5 to be positioned and fixed are completely or partially enclosed by them or secured by them in a clamping manner. This is also true for bearing shells 7 of the sliding bearings or rolling bearings 8, a transformer 9, a control unit 10, a motor 11 arranged in the longitudinal extension of the bottom shell 2 in FIG. 1, and also for individual parts of a gear unit 12 with the associated driven shaft 13 of the gear unit. Further, FIGS. 1 and 2 also show connection pieces 22 which serve as the connection between the bottom shell 2 and top shell 3. The through-holes and screws which are visible at the top shell 3 can be covered by a panel, not shown. Vent slots, designated by 21, serve to carry off heat.

The embodiment form according to FIG. 2 substantially corresponds to the embodiment form according to FIG. 1 with respect to the construction of the receptacles 6. The top shell 3 substantially covers only the mechanical portion of the drive elements 5, i.e., in this case, a spur gear unit with a motor 11 lying crosswise. The control area of the housing 4 is closed but is still accessible by means of a space 25 located behind the enclosure opposite from the gear unit 12.

The embodiment example according to FIG. 3 likewise corresponds substantially to the embodiment examples according to FIGS. 1 and 2. The top shell 3 is constructed so as to be divided with respect to the longitudinal extension of the door closer 1, so that the area of the control unit 10 on one side and the area of the mechanical drive elements 5 on the other side can be opened selectively in case of repair.

In the embodiment example according to FIG. 4, the drive elements 5 are held exclusively by receptacles 6 which are constructed as holding claws 16 and which are formed integral with the base 14 or the side walls 15 of the bottom shell 2. In this way, the motor 11 and gear unit 12 form an individual structural unit. In the embodiment example according to FIG. 4, receptacles 6 in a top shell 3 are omitted.

It is clear from FIG. 5 that the motor shown in FIG. 5 can be used in the embodiment example according to FIG. 4. As can be seen, a motor housing has been omitted in this case, so that a rotor 18, a stator 19 and a collector 20 are positioned and fixed by the bearing shells 7 of the sliding or rolling bearings 8 by means of the holding claws 16 described above.

### Reference Numbers

1 door drive
2 bottom shell
3 top shell
4 housing
5 drive elements
6 receptacles
7 bearing shells
8 sliding or rolling bearings
9 transformer
10 control unit
11 motor
12 gear unit
13 driven shaft of the gear unit
14 base of the bottom shell
15 side wall of the bottom shell
16 holding claws
17 motor shaft
18 rotor
19 stator
20 collector
21 vent slots
22 connection pieces
23 connection sleeves
24 enclosure
25 space

1-12. (canceled)

13. An electromechanical drive unit of a door closer for swiveling a door leaf, said unit comprising:
a housing comprising a top shell and a bottom shell;
drive elements received in the housing; and
receptacles in the housing for fixing the position of the drive elements, each drive element being inserted in at least one said receptacle, each said receptacle being formed in one piece with one of said top shell and said bottom shell.

14. The electromechanical drive unit of claim 13 wherein said drive elements comprise bearing shells for one of sliding and rolling bearings, said receptacles at least partially enclosing said bearing shells.

15. The electromechanical drive unit of claim 13 wherein said receptacles comprise complementary receptacles formed in one piece with said top shell and with said bottom shell.

16. The electromechanical drive unit of claim 13 further comprising a metal insert in at least one of said receptacles.

17. The electromechanical drive unit of claim 15 wherein said drive elements frictionally engage the receptacles in the top shell, thereby fixing the position of the drive elements in the receptacles in the bottom shell.

18. The electromechanical drive unit of claim 13 wherein said receptacles are formed as one piece with said bottom shell, said drive elements comprising at least a motor and a gear unit having a driven shaft, said drive elements being inserted in said receptacles formed in one piece with said bottom shell, the position of said drive elements being fixed by connecting said top shell to said bottom shell.

19. The electromechanical drive unit of claim 13 wherein said top shell and said bottom shell both extend the entire length of the housing.

20. The electromechanical drive unit of claim 18 wherein said top shell is shorter than said bottom shell, said top shell extending over said motor and said gear unit.

21. The electromechanical drive unit of claim 18 wherein said drive elements further comprise a transformer and a control unit, said top shell comprising a first portion extending over said motor and said gear unit, and a separate second portion extending over said transformer and said control unit.

22. The electromechanical drive unit of claim 13 wherein said bottom shell comprises a base and sidewalls, said receptacles being constructed as holding claws formed as one piece with at least one of said base and said sidewalls, said drive elements comprising a control unit, a motor having a shaft, and a gear unit.

23. The electromechanical drive unit of claim 22 further comprising bearing shells for said motor shaft, said bearing shells being received in said holding claws, said motor lacking a motor housing.

24. The electromechanical drive unit of claim 13 wherein said housing is made of one of plastic, die-cast zinc, and die-cast aluminum.
